(19) United States
(12) Patent Application Publication
(10) Pub. No.: US 2025/0123895 A1
(43) Pub. Date: Apr. 17, 2025

(54) EXECUTION NODE PROVISIONING OF A DATA STORE WITH FAIRNESS DURING OVERSUBSCRIPTION

(71) Applicant: Snowflake Inc., Bozeman, MT (US)

(72) Inventor: Brian Charles Forney, Mountain View, CA (US)

(21) Appl. No.: 18/484,958

(22) Filed: Oct. 11, 2023

(51) Int. Cl. G06F 9/50

(52) U.S. Cl. CPC G06F 9/505; G06F 2209/5011; G06F 2209/503; G06F 2209/504

(57) ABSTRACT

A system and method of execution node provisioning of a data store with fairness during oversubscription. The method includes scanning, during a first iteration, a queue to identify a first batch of processing requests associated with a plurality of accounts. The method includes determining a total count of demanded execution nodes to satisfy the first batch of processing requests. The method includes determining, based on the total count of demanded execution nodes, an inability for a pool of available execution nodes of a data store to satisfy the first batch of processing requests. The method includes allocating, by a processing device, the first batch of processing requests to the pool of available execution nodes according to a rationing procedure to reduce a latency time associated with processing the first batch of processing requests.

### TECHNICAL FIELD

The present disclosure relates generally to data processing, and more particularly, to systems and methods of execution node provisioning of a data store with fairness during oversubscription.

### BACKGROUND

Data platforms are designed to connect businesses globally across many different workloads and unlock seamless data collaboration. One example of a data platform is a data store or data warehouse, which are enterprise systems used for the analysis and reporting of structured and semi-structured data from multiple sources. Devices may use a data platform for processing and storing data.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram depicting an example embodiment of a data processing platform 100, according to some embodiments;

FIG. 2 is a block diagram depicting the execution platform of FIG. 1, according to some embodiments;

FIG. 3 is a block diagram depicting an example environment for execution node provisioning of a data store with fairness during oversubscription, according to some embodiments;

FIG. 4A is a table depicting a single iteration that includes four requests from three accounts at a time when the pool includes 90 available execution nodes, according to some embodiments;

FIG. 4B is a table depicting the computations that are made by the resource manager 102 for each processing request when allocating execution nodes based on a single-iteration/EN rationing procedure;

FIG. 4C is a table depicting the computations that are made by the resource manager 102 for each processing request when allocating execution nodes based on a multi-iteration/EN rationing procedure;

FIG. 5 is a block diagram depicting an example of the resource manager 102 in FIG. 1 according to some embodiments;

FIG. 6 is a flow diagram depicting a method of execution node provisioning of a data store with fairness during oversubscription, according to some embodiments; and

FIG. 7 is a block diagram of an example computing device that may perform one or more of the operations described herein, in accordance with some embodiments.

### DETAILED DESCRIPTION

The conventional data store includes a group of interconnected execution nodes (e.g., servers) that are configured to process tasks/queries using data. A management service of the data store processes a persistent queue of queries including, for example, suspend, resume, and/or resize queries. For resume and resize queries that enlarge the size of the data store, the management service makes allocation decisions to determine whether a query is to receive execution nodes from a pool (e.g., group) of available execution nodes of the data store. The conventional data store periodically scans its queue and processes the one or more queries in scan order to form an iteration. However, this can lead to situations where a particular customer account may consume a large fraction of the pool of available execution nodes in a short period of time. A similar phenomenon can occur for particular data store sizes where a single data store size-possibly across more than one query-consumes a large fraction of the pool of available execution nodes.

Aspects of the present disclosure address the above-noted and other deficiencies by disclosing a resource manager (sometimes referred to as a Warehouse Maintenance Service (WMS)) that identifies, from a data store of execution nodes, a pool of available execution nodes to process queries and allocate the pool of available execution nodes to the queries based on an execution node (EN) rationing procedure that accounts for customer account characteristics (e.g., number of customer accounts) and/or the pool size. The resource manager implements this procedure upon determining that allocating execution nodes from the pool to the queries would force the data store into an oversubscription (e.g., constrained) state, such that the number of available execution nodes in the pool is less than the demanded execution node (to process the queries) in a single iteration.

As discussed in greater detail below, a resource manager is communicatively coupled to an execution platform that includes one or more data stores (e.g., data platform), each including one or more execution nodes (e.g., a processing device of a server). The resource manager scans, during a first iteration, a queue to identify a first batch of processing requests associated with a plurality of accounts. The resource manager determines a total count of demanded execution nodes to satisfy the first batch of processing requests. The resource manager determines, based on the total count of demanded execution nodes, an inability for a pool of available execution nodes of a data store to satisfy the first batch of processing requests. The resource manager allocates the first batch of processing requests to the pool of available execution nodes according to a rationing procedure to reduce a latency time associated with processing the first batch of processing requests.

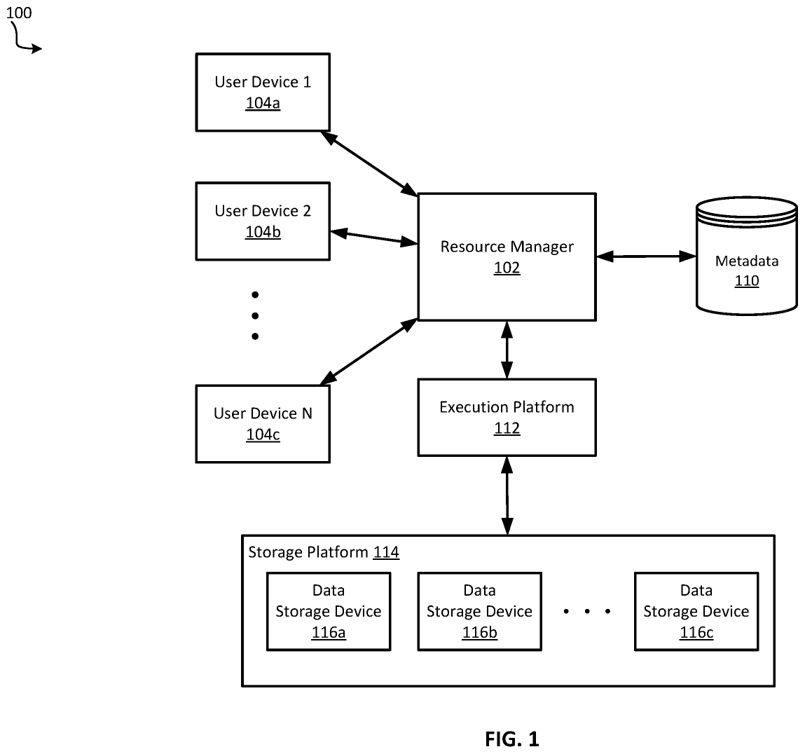

FIG. 1 is a block diagram depicting an example embodiment of a data processing platform 100, according to some embodiments. As shown in FIG. 1, a resource manager 102 is coupled to multiple user devices 104 (e.g., user devices 104a, 104b, 104c, etc.). In particular implementations, resource manager 102 can support any number of user device desiring access to data processing platform 100. User device 104 may include, for example, end user device providing data storage and retrieval requests, system administrators managing the systems and methods described herein, and other components/devices that interact with resource manager 102. Resource manager 102 provides various services and functions that support the operation of all systems and components within data processing platform 100. As used herein, resource manager 102 may also be referred to as a “Warehouse Maintenance Service (WMS)” that performs various functions as discussed herein.

Resource manager 102 is also coupled to metadata 110, which is associated with the entirety of data stored throughout data processing platform 100. In some embodiments, metadata 110 includes a summary of data stored in remote data storage systems as well as data available from a local cache. Additionally, metadata 110 may include information regarding how data is organized in the remote data storage systems and the local caches. Metadata 110 allows systems and services to determine whether a piece of data needs to be accessed without loading or accessing the actual data from a storage device.

Resource manager 102 is further coupled to an execution platform 112, which provides multiple computing resources that execute various data storage and data retrieval tasks, as discussed in greater detail below. Execution platform 112 is coupled to multiple data storage devices 116 (e.g., data storage device 116a, data storage device 116b, data storage device 116c, etc.) that are part of a storage platform 114. In some embodiments, the data storage devices 116 are cloud-based storage devices located in one or more geographic locations. For example, data storage devices 116 may be part of a public cloud infrastructure or a private cloud infrastructure. Data storage devices 116 may be hard disk drives (HDDs), solid state drives (SSDs), storage clusters, Amazon S3™ storage systems or any other data storage technology. Additionally, storage platform 114 may include distributed file systems (e.g., Hadoop Distributed File Systems (HDFS)), object storage systems, and/or the like.

In particular embodiments, the communication links between resource manager 102 and user devices 104, metadata 110, and execution platform 112 are implemented via one or more data communication networks. Similarly, the communication links between execution platform 112 and data storage devices 116 in storage platform 114 are implemented via one or more data communication networks. These data communication networks may utilize any communication protocol and any type of communication medium. In some embodiments, the data communication networks are a combination of two or more data communication networks (or sub-networks) coupled to one another. In alternate embodiments, these communication links are implemented using any type of communication medium and any communication protocol.

As shown in FIG. 1, data storage devices 116 are decoupled from the computing resources associated with execution platform 112. This architecture supports dynamic changes to data processing platform 100 based on the changing data storage/retrieval needs as well as the changing needs of the users and systems accessing data processing platform 100. The support of dynamic changes allows data processing platform 100 to scale quickly in response to changing demands on the systems and components within data processing platform 100. The decoupling of the computing resources from the data storage devices supports the storage of large amounts of data without requiring a corresponding large amount of computing resources. Similarly, this decoupling of resources supports a significant increase in the computing resources utilized at a particular time without requiring a corresponding increase in the available data storage resources.

Resource manager 102, metadata 110, execution platform 112, and storage platform 114 are shown in FIG. 1 as individual components. However, each of resource manager 102, metadata 110, execution platform 112, and storage platform 114 may be implemented as a distributed system (e.g., distributed across multiple systems/platforms at multiple geographic locations). Additionally, each of resource manager 102, metadata 110, execution platform 112, and storage platform 114 can be scaled up or down (independently of one another) depending on changes to the requests received from user devices 104 and the changing needs of data processing platform 100. Thus, in the described embodiments, data processing platform 100 is dynamic and supports regular changes to meet the current data processing needs.

During operation, data processing platform 100 processes multiple request or queries (shown in FIG. 1 as task processing query) received from any of the user devices 104. These queries are managed by resource manager 102 to determine when and how to execute the queries. For example, resource manager 102 may determine what data is needed to process the query and further determine which nodes within execution platform 112 are best suited to process the query. Some nodes may have already cached the data needed to process the query and, therefore, are good candidates for processing the query. Metadata 110 assists resource manager 102 in determining which nodes in execution platform 112 already cache at least a portion of the data needed to process the query. One or more nodes in execution platform 112 process the query using data cached by the nodes and, if necessary, data retrieved from storage platform 114. It is desirable to retrieve as much data as possible from caches within execution platform 112 because the retrieval speed is typically much faster than retrieving data from storage platform 114.

As shown in FIG. 1, data processing platform 100 separates execution platform 112 from storage platform 114. In this arrangement, the processing resources and cache resources in execution platform 112 operate independently of the data storage resources 116 in storage platform 114. Thus, the computing resources and cache resources are not restricted to specific data storage resources 116. Instead, all computing resources and all cache resources may retrieve data from, and store data to, any of the data storage resources in storage platform 114. Additionally, data processing platform 100 supports the addition of new computing resources and cache resources to execution platform 112 without requiring any changes to storage platform 114. Similarly, data processing platform 100 supports the addition of data storage resources to storage platform 114 without requiring any changes to nodes in execution platform 112.

Although FIG. 1 shows only a select number of computing devices (e.g., user device 104, resource manager 102), execution platforms (e.g., execution platform 112), and storage platforms (storage platform 114); the environment 100 may include any number of computing devices, execution platforms, and/or storage platforms that are interconnected in any arrangement to facilitate the exchange of data between the computing devices and the platforms. For example, the resource manager 102 may be coupled to multiple execution platforms 112. Additionally, the storage platform 114 may include any number of data storage devices 116a.

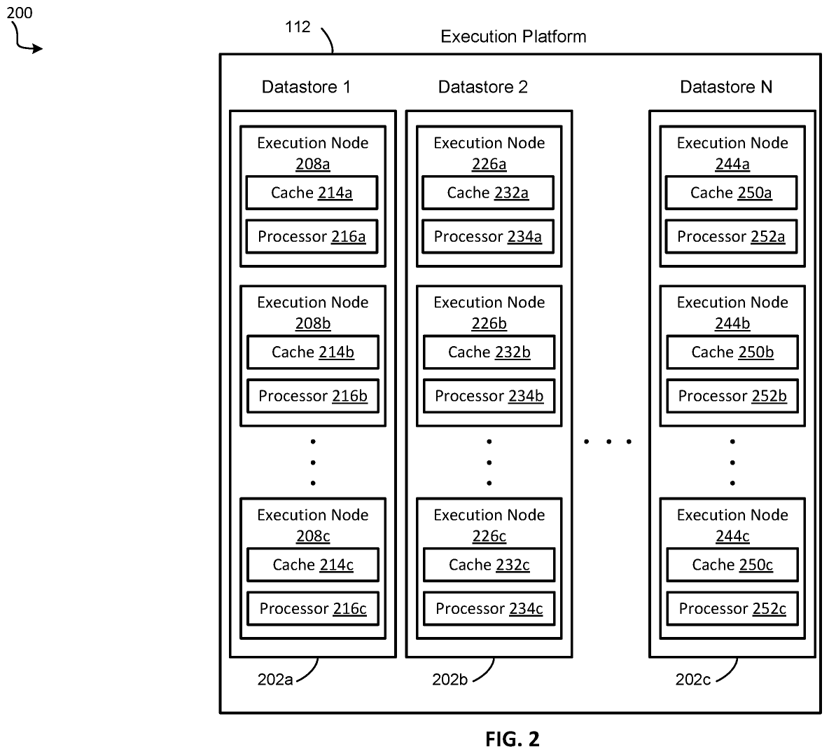

FIG. 2 is a block diagram depicting the execution platform of FIG. 1, according to some embodiments. The execution platform 112 includes multiple data stores 202 (e.g., data stores 204a, 204b, 204c), according to some embodiments. Each data store 202 includes multiple execution nodes that each include a data cache and a processor. Specifically, data store 202a includes execution nodes 208 (e.g., execution nodes 208a, 208b, 208c), cache 214 (e.g., cache 214a, 214b, 214c), and processors 216 (e.g., processor 216a, 216b, 216c); data store 202b includes execution nodes 226 (e.g., execution nodes 226a, 226b, 226c), cache 232 (e.g., cache 232a, 232b, 232c), and processors 234 (e.g., processor 234a, 234b, 234c); and data store 202c includes execution nodes 244 (e.g., execution nodes 244a, 244b, 244c), cache 250 (e.g., cache 250a, 250b, 250c), and processors 252 (e.g., processor 252a, 252b, 252c). In some embodiments, an execution node may be a central processing unit (CPU).

Each execution node includes a cache and a processor. Specifically, with regard to data store 202a, execution node 208a includes cache 214a and processor 216a; execution node 208b includes cache 214b and processor 216b; execution node 208c includes cache 214c and processor 216c. With regard to data store 202b, execution node 226a includes cache 232a and processor 234a; execution node 226b includes cache 232b and processor 234b; execution node 226c includes cache 232c and processor 234c. With regard to data store 202c, execution node 244a includes cache 250a and processor 252a; execution node 244b includes cache 250b and processor 252b; execution node 244c includes cache 250c and processor 252c.

Each of the execution nodes 208, 226, 244 is associated with processing one or more data storage and/or data retrieval tasks. For example, a particular data store may handle data storage and data retrieval tasks associated with a particular user or customer. In other implementations, a particular data store may handle data storage and data retrieval tasks associated with a particular data storage system or a particular category of data.

Data stores 202 are capable of executing multiple queries (and other tasks) in parallel by using the multiple execution nodes. As discussed herein, execution platform 112 can add new data stores and drop existing data stores in real time based on the current processing needs of the systems and users. This flexibility allows execution platform 112 to quickly deploy large amounts of computing resources when needed without being forced to continue paying for those computing resources when they are no longer needed. All data stores can access data from any data storage device (e.g., any storage device in storage platform 114 in FIG. 1).

A data store may be any type of system used for the processing and reporting of structured and semi-structured data from multiple sources, including for example, one or more database servers, a data warehouse, a virtual warehouse, a data lake, a data pond, a data mesh, and/or the like.

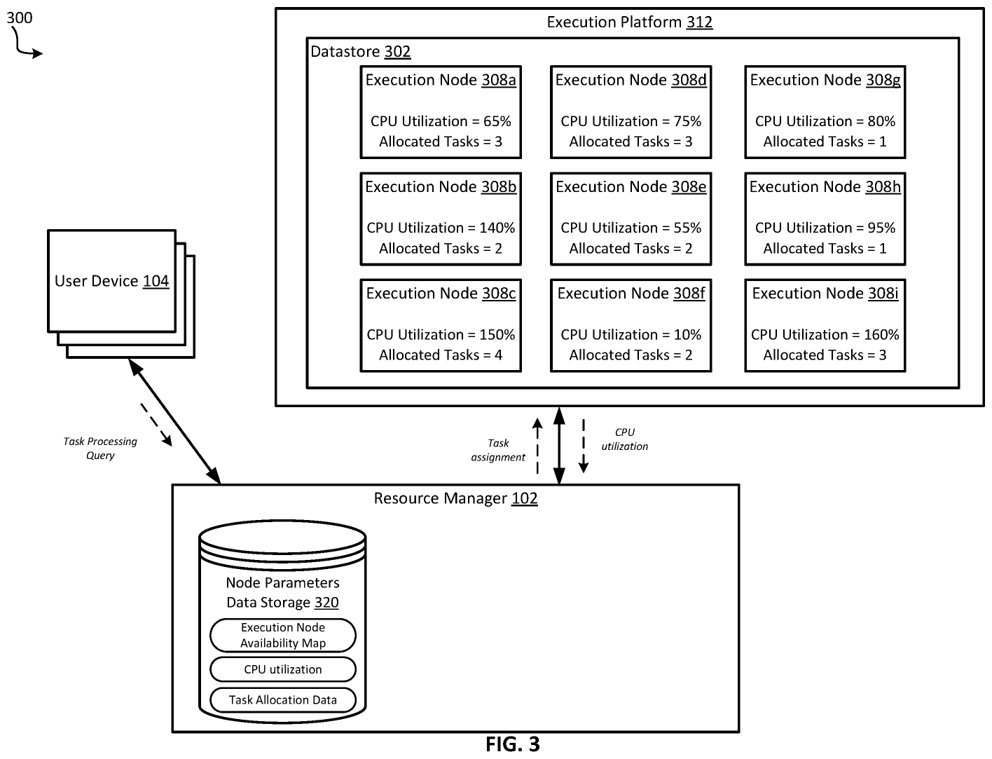

Although each data store 202 shown in FIG. 3 includes three execution nodes, a particular data store may include any number of execution nodes. Further, the number of execution nodes in a data store is dynamic, such that new execution nodes are created when additional demand is present, and existing execution nodes are deleted when they are no longer necessary.

Each data store 202 is capable of accessing any of the data storage devices 116 shown in FIG. 1. Thus, data stores 202 are not necessarily assigned to a specific data storage device 116 and, instead, can access data from any of the data storage devices 116. Similarly, each of the execution nodes shown in FIG. 2 can access data from any of the data storage devices 116. In some embodiments, a particular data store or a particular execution node may be temporarily assigned to a specific data storage device, but the data store or execution node may later access data from any other data storage device.

In some embodiments, the execution nodes shown in FIG. 2 are stateless with respect to the data the execution nodes are caching. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 2 each include one data cache and one processor, alternate embodiments may include execution nodes containing any number of processors and any number of caches. Additionally, the caches may vary in size among the different execution nodes. The caches shown in FIG. 2 store, in the local execution node, data that was retrieved from one or more data storage devices in storage platform 114 in FIG. 1. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes which is significantly faster and avoids the bottleneck problem discussed above. In some embodiments, the caches are implemented using high-speed memory devices that provide fast access to the cached data. Each cache can store data from any of the storage devices in storage platform 114.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some embodiments, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, a particular execution node may be assigned more processing resources if the tasks performed by the execution node become more processor intensive. Similarly, an execution node may be assigned more cache resources if the tasks performed by the execution node require a larger cache capacity.

Although data stores 202 are associated with the same execution platform 112, the data stores 202 may be implemented using multiple computing systems at multiple geographic locations. For example, data store 202a can be implemented by a computing system at a first geographic location, while data stores 202b and 202c are implemented by another computing system at a second geographic location. In some embodiments, these different computing systems are cloud-based computing systems maintained by one or more different entities.

Additionally, each data store 202 is shown in FIG. 2 as having multiple execution nodes. The multiple execution nodes associated with each data store 202 may be implemented using multiple computing systems at multiple geographic locations. For example, a particular instance of data store 202 implements execution nodes 308a-c on one computing platform at a particular geographic location and implements execution nodes 308d-308f at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the data store.

Execution platform 112 is also fault tolerant. For example, if one data store 202 fails, that data store 202 is quickly replaced with a different data store 202 at a different geographic location.

A particular execution platform 112 may include any number of data stores 202. Additionally, the number of data stores 202 in a particular execution platform 112 is dynamic, such that new data stores 202 are created when additional processing and/or caching resources are needed. Similarly, existing data stores 202 may be deleted when the resources associated with the data store 202 are no longer necessary.

In some embodiments, each of the data stores 202 may operate on the same data in storage platform 114, but each data store 202 has its own execution nodes with independent processing and caching resources. This configuration allows requests on different data stores 202 to be processed independently and with no interference between the requests. This independent processing, combined with the ability to dynamically add and remove data stores 202, supports the addition of new processing capacity for new users without impacting the performance observed by the existing users.

FIG. 3 is a block diagram depicting an example environment for execution node provisioning of a data store with fairness during oversubscription, according to some embodiments. Specifically, the environment 300 shows how the resource manager 102 in FIG. 1 may be configured to identify, from the data store 302 of execution nodes, a pool of available execution nodes 308 to process queries and allocate the pool of available execution nodes 308 to the queries based on an EN-rationing procedure that accounts for customer account characteristics (e.g., number of customer accounts) and/or the pool size. The resource manager 102 implements this procedure upon determining that allocating the pool of available execution nodes 308 to the queries would force the data store 302 into an oversubscription (e.g., constrained) state, such that the number of available execution nodes 308 in the pool is less than the demanded execution node (to process the queries) in a single iteration. As shown in FIG. 3, the environment 300 includes one or more user devices 104, resource manager 102, and an execution platform 312 that are each communicatively coupled to one another via a communication network. The execution platform 212, which may correspond to execution platform 212 in FIG. 2, includes data store 302, which may correspond to data store 202a (data store 1), data store 202b (data store 2), or any other data store 202c (data store N) in FIG. 2.

The data store 302 includes execution node 308a, execution node 308b, execution node 308c, execution node 308d, execution node 308e, execution node 308f, execution node 308g, execution node 308h, and execution node 308i (collectively referred to as, execution nodes 308). Each execution node 308 may correspond to a respective execution node within the particular data store in FIG. 2. For example, if data store 302 corresponds to data store 202a in FIG. 2, then execution node 308a corresponds to execution node 208a of data store 202a, execution node 308b corresponds to execution node 208b of data store 202a, and execution node 308c corresponds to execution node 208c of data store 202a. Each of the remaining execution nodes 308d-308i then respectively correspond to one of the other execution nodes of data store 202a. Although FIG. 3 only shows a single data store 302, the resource manager 102 in FIG. 3 may perform the same EN rationing procedure, as described herein, for any other data stores 302 (e.g., data store 202b, data store 202c, etc.) that are communicatively coupled to the resource manager 102. Furthermore, although FIG. 3 shows that data store 302 only includes a select number of execution node (e.g., execution nodes 308a-308i), a data store may include any number (e.g., 1 or multiple) of execution nodes.

Each execution node 308 is configured to receive one or more tasks (sometimes referred to as, queries, allocated tasks, task assignment) from the resource manager 102, store the tasks in its local queue (e.g., a collection of tasks that are maintained in a chronological sequence in a memory or data storage), and process the tasks in the order in which they are received. The execution node 308 uses a percentage of its processing/computing capability (e.g., CPU utilization) to process the task. That is, a CPU time or process time is the amount of time for which a central processing unit, such as an execution node 308, is used for processing instructions (e.g., a task) of a computer program or operating system. The CPU time may be measured in clock ticks or seconds. A CPU utilization (or CPU usage) is a measurement of CPU time as a percentage of the CPU's capacity.

FIG. 3 depicts an example snapshot of the CPU utilization for each execution node 308 of the data store 302. Specifically, at a particular snapshot (referred to herein as snapshot 1) of the data store 302, the execution node 308a has a CPU utilization of 65% and has 3 allocated tasks, execution node 308b has a CPU utilization of 140% and has 2 allocated tasks, execution node 308c has a CPU utilization of 150% and has 4 allocated tasks, execution node 308d has a CPU utilization of 75% and has 3 allocated tasks, execution node 308e has a CPU utilization of 55% and has 2 allocated tasks, execution node 308f has a CPU utilization of 10% and has 2 allocated tasks, execution node 308g has a CPU utilization of 80% and has 1 allocated task, execution node 308h has a CPU utilization of 95% and has 1 allocated task, and execution node 308i has a CPU utilization of 160% and has 3 allocated tasks. The CPU utilization for each execution node 308 is based on the number of tasks allocated to the execution node 308 and the amount of work the execution node 308 performs to execute the task. Thus, different snapshots of the execution node performance at different moments in time can show how these values (e.g., CPU utilization and allocated task) change over time.

The allocated tasks of an execution node 308 may, in some embodiments, refer to the total number of tasks in the queue of the execution node 308 plus whether the execution node 308 is currently processing a task. For example, execution node 308a has 3 allocated tasks because the execution node 308a has two tasks in its queue and is currently processing a third task.

To perform some tasks, in some embodiments, the execution node 308 first downloads one or more files from a remote storage (e.g., cloud, internet, etc.). As the execution node 308 waits for the one or more files to be fully downloaded, its CPU utilization may be drastically reduced. The resource manager 102 is aware of these moments of time when the execution node is downloading files because the resource manager 102 is continually determining the CPU utilization (either an estimate CPU utilization or an actual CPU utilization) of the execution node 308. That is, the resource manager 102 may calculate an estimate CPU utilization based on knowing the number and type of jobs (including knowing which files are needed to process the job) that are assigned to the execution node 308. Alternatively, the resource manager 102 may determine the actual CPU utilization based on receiving feedback information indicative of the actual CPU utilization of the execution node 308. Thus, the resource manager 102 may maximize the capability of the execution node 308 by allocating additional tasks to the execution node 308 to cause the execution node 308 to process the additional tasks during the moments of time when the execution node 308 is waiting for the files to be downloaded.

The resource manager 102 may monitor the current CPU utilization of each of the execution nodes 308 of the data store 302. The resource manager 102 may send a request to each of the execution nodes 308 for the execution nodes 308 to begin periodically reporting their current CPU utilization to the resource manager 102. Upon receiving the CPU utilizations, the resource manager 102 assigns a time stamp to each of the CPU utilizations and stores the CPU utilizations and time stamps in the node parameters data storage 130. The execution nodes 308 may periodically report their current CPU utilization to the resource manager 102 based on an elapse of time (e.g., every second, every minute, and/or the like) and/or whenever a particular event occurs, such as, when the execution node 308 begins processing the next task in its queue or when the CPU utilization of the execution node 308 increases or decreases by a particular amount (e.g., 1%, 2%, etc.) as compared to the CPU utilization of a previous time frame (e.g., prior 30 seconds, 60 seconds, 1 minute, etc.).

The resource manager 102 may keep track of which tasks (e.g., task 1, task 2, task 3, etc.) it assigns (e.g., allocates, distributes) to which execution node 308 of the data store 302, as well as the time stamp in which the resource manager 102 assigns the particular task to the particular execution node 308. The resource manager 102 stores this information (referred to herein as, task allocation data) in the node parameter data storage 320. The task allocation data also indicates the chronological order of the tasks that are in each of the queues of the execution nodes 308. In some embodiments, the load average statistics for an execution node 308 may lag (e.g., delayed) by a particular lag amount (e.g., second, minutes), and if so, the resource manager 102 may avoid allocating tasks to the execution nodes 308 for up to a particular delay amount that is equal to the lag amount. For example, if the resource manager 102 determines that the load average statistics for execution node 308b is 5 seconds, then the resource manager 102 may wait (e.g., pause) for 5 seconds before allocating (e.g., assigning) tasks to any of the execution nodes 308 of the data store 302.

The resource manager 102 may receive a request (e.g., query) to process one or more tasks from a user device 104. In response, the resource manager 102 may generate an execution node (EN) availability map that indicates, for each execution node 308 in the data store 302, whether the execution node 308 is assigned to a pool of available execution nodes 308 or a pool of unavailable execution nodes 308. The pool of available execution nodes 308 are capable (e.g., ready, prepared) of accepting additional task assignments (e.g., queries), but the pool of unavailable execution nodes 308 are incapable of accepting any additional task assignments. The resource manager 102 stores the EN availability map in the node parameters data storage 320. The resource manager 102 may regenerate and update the EN availability map based on any triggering event including, for example, a timing event (e.g., every second, minute, etc.), responsive to receiving updated CPU utilizations from the data store 302, or responsive to determining that the updated CPU utilizations deviate from the previously stored CPU utilizations by a predetermined percentage (e.g., 1%, 5%, etc.). In some embodiments, the resource manager 102 may receive a request to process a task from a user device 104, and in response, determine whether an EN availability map that was previously stored in the node parameters data storage 320 is sufficient to use for query allocation decisions, instead of having to regenerate and update the EN availability map; thereby reducing the overall latency of processing a task.

The resource manager 102 may generate an EN availability map by identifying a pool (e.g., a single execution node or a plurality) of available execution nodes 308 of the data store 302 and a pool of unavailable execution nodes 308 of the data store 302 based on the current CPU utilizations and/or the task allocation data that are stored in the node parameters data storage 320, a memory of the resource manager 102, and/or a cache of the resource manager 102.

Specifically, the resource manager 102 may compare the current CPU utilization of an execution node 308 to a predetermined threshold (e.g., 90%). If the current CPU utilization is less than the predetermined threshold, then the resource manager 102 determines that the execution node 308 is available to process the query, and therefore assigns the execution node 308 to a pool of available execution nodes 308. Alternatively, if the current CPU utilization is greater than or equal to the predetermined threshold, then the resource manager 102 determines that the execution node 308 is unavailable to process the query, and therefore assigns the execution node 308 to a pool of unavailable execution nodes 308. The resource manager 102 repeats this classification procedure for each of the execution nodes 308 in the data store 302, generates EN availability map based on the results, assigns a time stamp to EN availability map, and stores the EN availability map in the node parameters data storage 320.

In addition, the resource manager 102 may compare the current task allocation data to a predetermined threshold (e.g., 1, 2, 3). If the current task allocation data for an execution node 308 is less than the predetermined threshold, then the resource manager 102 determines that the execution node 308 is available to process the query, and therefore assigns the execution node 308 to a pool of available execution nodes 308. Alternatively, if the current task allocation data is greater than or equal to the predetermined threshold, then the resource manager 102 determines that the execution node 308 is unavailable to process the query, and therefore assigns the execution node 308 to a pool of unavailable execution nodes 308. The resource manager 102 repeats this classification procedure for each of the execution nodes 308 in the data store 302, generates EN availability map based on the results, assigns a time stamp to EN availability map, and stores the EN availability map in the node parameters data storage 320.

The resource manager 102 decides whether to satisfy an allocate-type query, such as a task processing query. The resource manager 102 may use a conventional procedure for allocating execution nodes 308 of the data store 302 to the one or more tasks of the processing query. The conventional procedure includes a decision metric of whether the query can be satisfied by the current pool of available execution nodes 308. In other words, if the resource manager 102 determines that a number of requested execution nodes 308 to process the query is less than or equal to the number of available execution nodes 308 in the pool of available execution nodes 308 (of the requested type), then the resource manager 102 may decide to satisfy the processing query; otherwise, the resource manager 102 does not satisfy the processing query and instead considers whether to process the query in one or more future iterations. Consequently, processing queries from a particular group might allocate large fractions of its aggregate number of execution nodes 308, while other query groups might receive a small fraction of its queries. This is due to runs of queries from a single grouping and queries with a large number of requested servers, such as when the grouping is sized.

Therefore, the present disclosure provides several EN rationing procedures for rate limiting to address the above-noted and other deficiencies of the conventional procedure. Each of the EN rationing procedures are described below.

### Single-Iteration/EN Rationing Procedure

The resource manager 102 may allocate a pool of available execution nodes 308 to one or more queries based on the single-iteration/EN rationing procedure. That is, the resource manager 102 may logically split the queries and/or tasks using a grouping, such as customer account characteristics (e.g., number of customer accounts) and/or size of the data store 302, and then ensure that one group does not get significantly ahead of other groups based on a comparison of a total considered demand and a considered demand for the grouping.

Specifically, using a single iteration, the resource manager 102 counts the number of requested execution nodes 308 for each grouping (e.g., account), stores the values in a total demand vector, and sum the values to get a total demand. In addition to the demand vector, the resource manager 102 maintains a considered demand vector, which contains the running sum of the queries that have had an allocation decision made. The resource manager 102 initializes the considered demand vector at the beginning of an iteration to zero for each group in the demand vector. Finally, the resource manager 102 maintains a sum of all the running sums in the considered demand vector.

Using these four pieces of information, the resource manager 102 can compute two values: (1) the percent of total demand considered and (2) the percent of demand considered for a grouping. The resource manager 102 computes these values for each considered task processing query. Using these values, the resource manager 102 can determine during an allocation decision whether the grouping has demanded more execution nodes 308 than has been considered in a single iteration. If the resource manager 102 determines that the percent of demand considered for a grouping is less than or equal to the percent of total demand considered, then the resource manager 102 satisfies the query; otherwise, the resource manager 102 skips the query in the current iteration and considers the query in the next iteration. The resource manager 102 updates the considered demand vector after each query is considered.

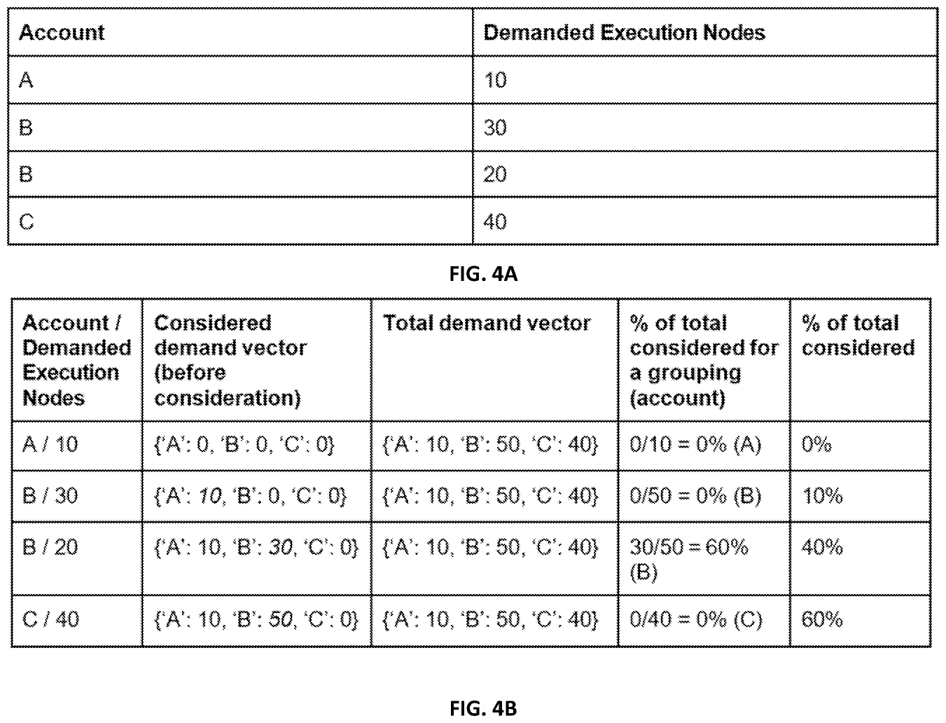

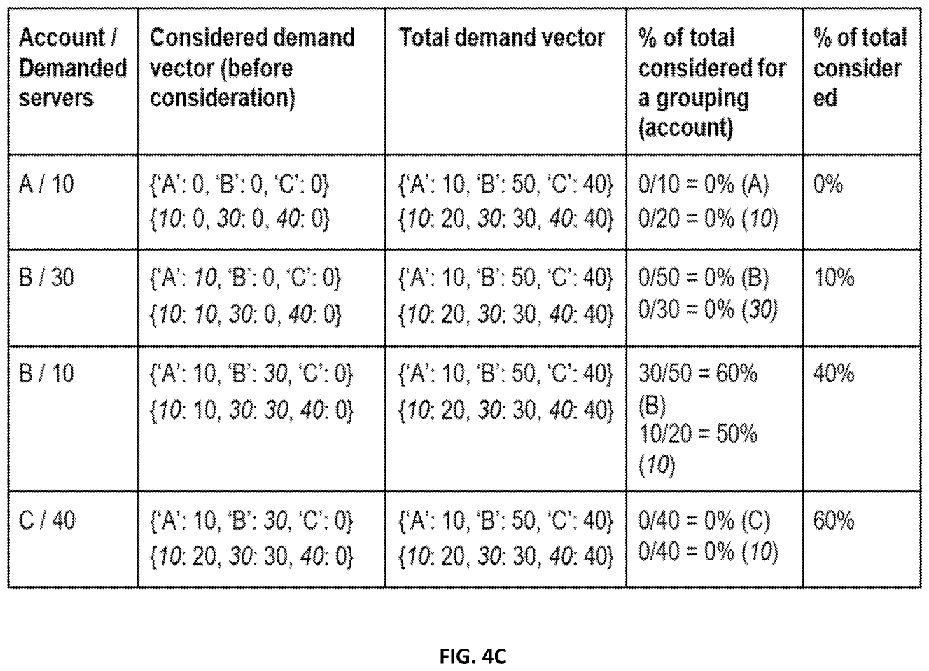

The single-iteration/EN rationing procedure will now be explained with an example using FIG. 4A and FIG. B.

FIG. 4A is a table depicting a single iteration that includes four processing requests from three accounts (e.g., customer accounts) at a time when the pool includes 90 available execution nodes, according to some embodiments. Specifically, the resource manager 102 receives in chronological order a first processing request (e.g., a task processing query) from Account A that demands 10 execution nodes; a second processing request from Account B that demands 30 execution nodes; a third processing request from Account B that demands 20 execution nodes; and a fourth processing request from Account C that demands 40 execution nodes. The single iteration (sometimes referred to as a batch) includes the first processing request, the second processing request, the third processing request, and the fourth processing request. In some embodiments, the resource manager may receive multiple requests (instead of a single request) from a single account having multiple execution platforms 312 (e.g., warehouses) in FIG. 3.

For the single iteration results of FIG. 4A, the resource manager 102 calculates (e.g., generates, measures) a total demand vector of ({‘A’: 10, ‘B’: 50, ‘C’: 40}). Note that the resource manager 102 calculated 50 for B by adding 20 and 30. The resource manager 102 then adds the total number of execution nodes 308 to process the processing requests so to compute a total demand of 100 execution nodes (e.g., 10+50+40). Based on these calculations, the resource manager 102 determines that the system is in a constrained state because the total demand of execution nodes to process the queries for the single iteration is greater than the number of available execution nodes 308 in the pool. The resource manager 102 also calculates a considered demand vector of ({‘A’: 0, ‘B’: 0, ‘C’: 0}) by zeroing out the values of the total demand vector.

FIG. 4B is a table depicting the computations that are made by the resource manager 102 for each processing request when allocating execution nodes 308 based on a single-iteration/EN rationing procedure, according to some embodiments. The table includes a first column (Account/Demanded Execution Nodes), a second column (Considered demand vector (before consideration)), a third column (total demand vector), a fourth column (percent of total considered for an account), and a fifth column (percent of total considered). With the total demand vector in the third column staying as a constant of ({‘A’: 10, ‘B’: 50, ‘C’: 40}), the resource manager 102 makes a different allocation decision for each row (each corresponding to a different processing request) of rows 1-4 in chronological order, as follows:

For row 1: The first column shows that Account A has demanded 10 execution nodes. The second column shows that the resource manager 102 calculates a considered demand vector of {‘A’: 0, ‘B’: 0, ‘C’: 0}. This vector is all zero because the resource manager 102 has not yet considered any requests from any of the accounts in this iteration. The third column shows that resource manager 102 maintains the total demand vector to a constant value. The fourth column shows that the resource manager 102 calculates a percent of total considered Account A as 0% by dividing the considered demand vector of 0 (e.g., shown in the second column) for Account ‘A’ by the total demand vector of 10 (e.g., shown in the third column) for Account A. The fifth column shows the resource manager 102 calculates a percent of total considered as 0% because it has not yet made any allocation decisions for any requests from any of the accounts in this iteration.

Using the calculations from row 1, the resource manager 102 determines that the percent of total considered for Account A of 0% is less than or equal to the percent of total considered of 0%, and therefore, the resource manager 102 determines to satisfy the processing request from Account A by allocating 10 execution nodes to Account A to process the processing request. The resource manager 102 updates the considered demand vector to be ({‘A’: 10, ‘B’: 0, ‘C’: 0}) to indicate that 10 execution nodes have been allocated to Account A.

For row 2: The first column shows that Account B has demanded 30 execution nodes. The second column shows that the resource manager 102 calculates a considered demand vector of {‘A’: 10, ‘B’: 0, ‘C’: 0}. The third column shows that resource manager 102 maintains the total demand vector to a constant value. The fourth column shows that the resource manager 102 calculates a percent of total considered for Account B as 0% by dividing the considered demand vector of 0 (e.g., shown in the second column) for Account ‘B’ by the total demand vector of 50 (e.g., shown in the third column) for Account B. The fifth column shows the resource manager 102 calculates a percent of total considered as 10% by adding the considered demand vector for each account (e.g., 10 for A+0 for B+0 for C=10) and dividing the sum by 100.

Using the calculations from row 2, the resource manager 102 determines that the percent of total considered for Account B of 0% is less than or equal to the percent of total considered of 10%, and therefore, the resource manager 102 determines to satisfy the processing request from Account B by allocating 30 execution nodes to Account B to process the processing request. The resource manager 102 updates the considered demand vector to be ({‘A’: 10, ‘B’: 30, ‘C’: 0}) to indicate that 30 execution nodes have been allocated to Account B.

For row 3: The first column shows that Account B has made a different request that demands 20 execution nodes. The second column shows that the resource manager 102 calculates a considered demand vector of {‘A’: 10, ‘B’: 30, ‘C’: 0}. The third column shows that resource manager 102 maintains the total demand vector to a constant value. The fourth column shows that the resource manager 102 calculates a percent of total considered for Account B as 60% by dividing the considered demand vector of 30 (e.g., shown in the second column) for Account ‘B’ by the total demand vector of 50 (e.g., shown in the third column) for Account B. The fifth column shows the resource manager 102 calculates a percent of total considered as 40% by adding the considered demand vector for each account (e.g., 10 for A+30 for B+0 for C=40) and dividing the sum by 100.

Using the calculations from row 3, the resource manager 102 determines that the percent of total considered for Account B of 60% is not less than or equal to the percent of total considered of 40%, and therefore, the resource manager 102 determines to not satisfy the processing request from Account B because it appears that Account B has “gotten ahead” of Accounts A and/or all other accounts managed by the resource manager 102. Thus, the resource manager does not allocate execution nodes to Account B for processing its different request that demanded 20 execution nodes, but the resource manager 102 does update the considered demand vector to {A: 10, ‘B’: 50, ‘C’: 0} to indicate that the resource manager 102 considered Account B's different request. The resource manager 102 may consider Account B's different request in the next iteration.

For row 4: The first column shows that Account C has demanded 40 execution nodes. The second column shows that the resource manager 102 calculates a considered demand vector of {‘A’: 10, ‘B’: 50, ‘C’: 0}. The third column shows that resource manager 102 continues to maintain the total demand vector to a constant value. The fourth column shows that the resource manager 102 calculates a percent of total considered for Account C as 0% by dividing the considered demand vector of 0 (e.g., shown in the second column) for Account ‘C’ by the total demand vector of 40 (e.g., shown in the third column) for Account C. The fifth column shows the resource manager 102 calculates a percent of total considered as 60% by adding the considered demand vector for each account (e.g., 10 for A+50 for B+0 for C=60) and dividing the sum by 100.

Using the calculations from row 4, the resource manager 102 determines that the percent of total considered for Account C of 0% is less than or equal to the percent of total considered of 60%, and therefore, the resource manager 102 determines to satisfy the processing request from Account C by allocating 40 execution nodes to Account C to process the processing request. The resource manager 102 updates the considered demand vector to be ({‘A’: 10, ‘B’: 30, ‘C’: 40}) to indicate that 40 execution nodes have been considered for Account C.

Thus, the table in FIG. 4b shows that the resource manager 102 agrees to satisfy (process) account A's request for 10 execution nodes, account B's processing request for 30 execution nodes, and account C's processing request for 40 execution nodes. However, the resource manager 102 does not satisfy account B's processing request for 20 execution nodes, and instead waits for the next iteration to reconsider account B's processing request.

The single-iteration/EN rationing procedure differs from the conventional allocation procedure in that requests are satisfied if there are enough servers in the free pool. The conventional procedure would satisfy the first three rows in the table in FIG. 4B. This would lead to Account A receiving 10 servers, Account B receiving 50 servers, and Account C receiving zero servers.

### Multi-Iteration/EN Rationing Procedure

The resource manager 102 may allocate a pool of available execution nodes 308 to one or more task processing queries and/or server requests based on the multi-iteration/EN rationing procedure. The single-iteration EN rationing procedure exhibits a priming effect, where the first request from a grouping (e.g., customer account) is satisfied by the resource manager 102 and is subject to allowing greater skew and lower averages across iterations. To lessen these effects, the resource manager 102 can maintain the history of the considered demand vector across iterations and the history of total demand vector across iterations. The resource manager 102 may maintain history by (1) using a sliding window approach, where decision making data is maintained for n iterations, or (2) using an exponential decay approach, where the historical data at the beginning of each iteration accumulates the last demand vectors and is decayed by multiplying it by a value between zero and one. The resource manager 102 may use either approach to add history. The sliding window approach has a strict history limit due to the windowing effect and might require maintaining in memory n versions of each demand vector. Conversely, the exponential decay approach has a less intuitive boundary since it reduces the effect of history using multiplication and might only require maintaining one copy of history during an iteration.

### Multi-Grouping

To handle more than one group/account, the resource manager 102 may use a considered demand vector and total demand vector for each grouping. Then, for each grouping (account), the resource manager 102 compares the percent of total demand considered and the percent of demand considered for the grouping. Only when each comparison for a request is true will the request be satisfied by the resource manager 102. For example, if the groupings are data store size and account, then (1) the resource manager 102 generates, for the data store size, a considered demand vector and total demand vector, and (2) the resource manager 102 generate, for the accounts, a considered demand vector and total demand vector. These respective vectors can then be used to compute the percent values and the comparisons can be made.

FIG. 4C is a table depicting the computations that are made by the resource manager 102 for each processing request when allocating execution nodes based on a multi-iteration/EN rationing procedure. That is, the table in FIG. 4C is an extension of the example using the single-iteration/EN rationing procedure in FIG. 4B. This example's salient point is when considering the third request. In this request, both the account group and size grouping are not less than the percent of total considered. Thus, the allocation is not made. All other allocations are granted.

### Parallel Scanning/Processing Iteration Execution for Multi-Grouping

In some embodiments, a single scanning iteration has been observed to become a bottleneck and negatively impact resume latency times. To mitigate (or eliminate) this bottleneck, resource manager 102 may run/process the iterations concurrently and in parallel. This parallelization requires no known changes to the single-iteration approach. The multi-iteration approach, however, requires considering what to do with history across the concurrent iterations. The resource manager 102 may create a serial order of iterations and create a history using the serial order. The ordering could be by the start time of an iteration. This would be a bit inaccurate but should work over the long run. Alternatively, history can be updated periodically when no concurrent iterations are running.

### Request Ordering

The ordering of requests within an iteration has an effect on fairness. Starvation can become more of an issue with particular ordering schemes. Starvation leads to higher resume latencies. The resource manager may order the requests according to a few possible methods, including: (1) process the release-type request first and then the allocate-type requests, (2) process from requests with the smallest warehouse size to requests with the largest warehouse size, or (3) process requests in queue arrival order.

The first ordering will increase the free pool before allocating servers (execution nodes) from it. This ordering leads to more free pool capacity in an iteration before the first allocate-type request is considered, increasing the likelihood that allocate-type requests will be satisfied. This design accepts the first ordering for its increase in likelihood of satisfying requests.

The second ordering is used in a prior approach. The rationale is that this keeps large requests from starving small requests. However, it can also starve large requests without any additional work to “boost the priority” of large requests after being considered multiple times. To handle both types of starvation the ordering needs to consider multiple pieces of data (data store size and age). How to handle each is not clear and prior attempts have introduced more knobs. Given the complexity this design doesn't consider this ordering policy further.

The third ordering is a first-come, first-considered ordering policy. This ordering makes sense as it reduces resume latency.

### Request Slicing

Resume requests today can be for multiple clusters within a warehouse. This makes for a large variance in the number of requested servers across requests. This makes the bin packing problem harder. To make this easier, in some embodiments, the resource manager 102 chooses processing requests at the per-cluster level.

The resource manager 102 performs cluster-level requests using one of two different methods: (1) pre-queue slicing, which involves storing allocation-type requests in a storage (e.g., FDB) as cluster-level requests, or (2) post-read slicing, which involves slicing requests after reading them from the storage.

Pre-queue slicing requires storing more commands in an FDB while making processing after dequeue simpler. Post-read slicing maintains the same number of commands in FDB, while requiring slicing of DPOs in memory. This in-memory slicing brings crash recovery into the picture as the sliced DPOs only exist in memory. Thus, any partial progress that is persisted will require persisting updated commands with the unsatisfied requests.

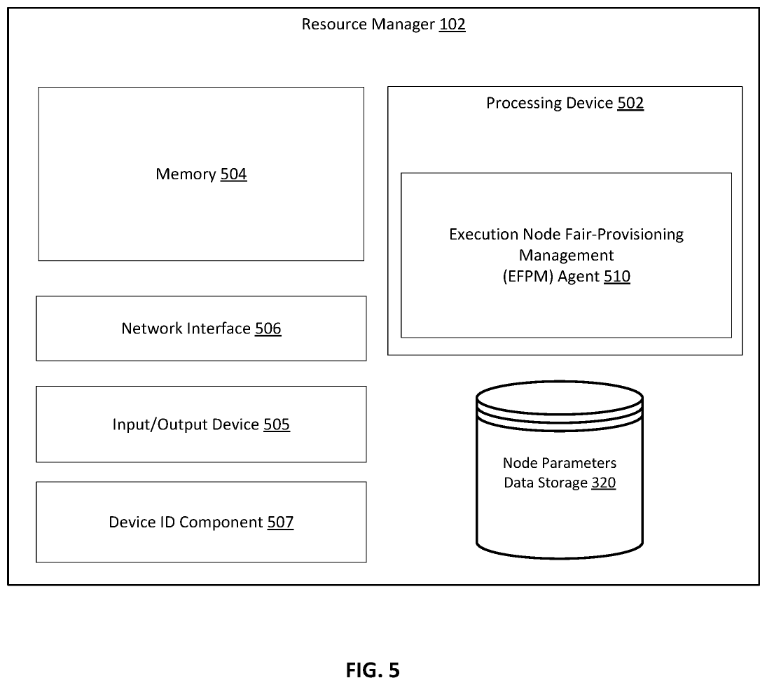

FIG. 5 is a block diagram depicting an example of the resource manager 102 in FIG. 1 according to some embodiments. While various devices, interfaces, and logic with particular functionality are shown, it should be understood that the resource manager 102 includes any number of devices and/or components, interfaces, and logic for facilitating the functions described herein. For example, the activities of multiple devices may be combined as a single device and implemented on a same processing device (e.g., processing device 502), as additional devices and/or components with additional functionality are included.

The resource manager 102 includes a processing device 502 (e.g., general purpose processor, a PLD, etc.), which may be composed of one or more processors, and a memory 504 (e.g., synchronous dynamic random-access memory (DRAM), read-only memory (ROM)), which may communicate with each other via a bus (not shown).

The processing device 502 may be provided by one or more general-purpose processing devices such as a microprocessor, central processing unit, or the like. In some embodiments, processing device 502 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. In some embodiments, the processing device 502 may include one or more special-purpose processing devices such as an application specific integrated circuit (ASIC), a field programmable gate array (FPGA), a digital signal processor (DSP), network processor, or the like. The processing device 502 may be configured to execute the operations described herein, in accordance with one or more aspects of the present disclosure, for performing the operations and steps discussed herein.

The memory 504 (e.g., Random Access Memory (RAM), Read-Only Memory (ROM), Non-volatile RAM (NVRAM), Flash Memory, hard disk storage, optical media, etc.) of processing device 502 stores data and/or computer instructions/code for facilitating at least some of the various processes described herein. The memory 504 includes tangible, non-transient volatile memory, or non-volatile memory. The memory 504 stores programming logic (e.g., instructions/code) that, when executed by the processing device 502, controls the operations of the resource manager 102. In some embodiments, the processing device 502 and the memory 504 form various processing devices and/or circuits described with respect to the resource manager 102. The instructions include code from any suitable computer programming language such as, but not limited to, C, C++, C #, Java, JavaScript, VBScript, Perl, HTML, XML, Python, TCL, and Basic.

The processing device 502 may include and/or execute an execution node fair-provisioning management (EFPM agent 510) agent 510 that may be configured to scan, during a first iteration, a queue to identify a first batch of processing requests associated with a plurality of accounts. The agent 510 that may be configured to determine a total count of demanded execution nodes to satisfy the first batch of processing requests. The agent 510 that may be configured to determine, based on the total count of demanded execution nodes, an inability for a pool of available execution nodes of a data store to satisfy the first batch of processing requests. In some embodiments, the pool of available execution nodes are unable to satisfy the first batch of processing requests because the total demanded execution nodes to process the first batch of processing requests is greater than the total number of available execution nodes 308 in the pool. The resource manager 102 may determine whether an execution node is available to process a request based on a current CPU utilization and/or a current task allocation associated with the execution node 308. The agent 510 that may be configured to allocate the first batch of processing requests to the pool of available execution nodes according to a rationing procedure to reduce a latency time associated with processing the first batch of processing requests.

The agent 510 that may be configured to determine, based on the total count of demanded execution nodes, the inability for the pool of available execution nodes of the data store to satisfy the first batch of processing requests by determining a total count of available execution nodes in the pool of available execution nodes; and determining that the total count of available execution nodes in the pool of available execution nodes is less than the total count of demanded execution nodes.

The agent 510 that may be configured to allocate the first batch of processing requests to the pool of available execution nodes according to the rationing procedure by generating a considered demand vector based on a first count of demanded execution nodes to process a first processing request associated with a first account of the plurality of accounts and a second count of demanded execution nodes to process a second processing request associated with a second account of the plurality of accounts.

In some embodiments, a total count of execution nodes that is indicated by the considered demand vector is less than the total count of demanded execution nodes. The agent 510 that may be configured to generate a total demand vector based on the total count of demanded execution nodes associated with the plurality of accounts.

The agent 510 that may be configured to calculate a total execution node considered for the second account based on the considered demand vector and the total demand vector. The agent 510 that may be configured to calculate a total considered for the second account based on the considered demand vector. The agent 510 that may be configured to determine that the total considered for the second account exceeds a predetermined threshold value. The agent 510 that may be configured to prevent an allocation of an execution node for processing the second processing request responsive to determining that the total considered for the second account exceeds the predetermined threshold value. The agent 510 that may be configured to scan, during a second iteration after preventing the allocation of the execution node for the processing the second processing request, the queue to identify a different batch of processing requests associated with the plurality of accounts.

The agent 510 that may be configured to allocate the first batch of processing requests to the pool of available execution nodes according to the rationing procedure to reduce the latency time associated with processing the first batch of processing requests by maintaining, over a plurality of scanning iterations, a history of at least one of a considered demand vector or a total demand vector based on a sliding window or an exponential decay procedure.

The agent 510 that may be configured to generate, based on a size of the data store, a first considered demand vector and first total demand vector. The agent 510 that may be configured to generate, based on the plurality of accounts, a second considered demand vector and a second total demand vector.

The agent 510 that may be configured to scan, during a second iteration, the queue to identify a second batch of processing requests associated with the plurality of accounts. The agent 510 that may be configured to process the first batch of processing requests and the second batch of processing requests in parallel.

The agent 510 that may be configured to process a release-type request before an allocate type request, process a first request having a smallest data store size before a second request having a largest data store size, and/or process the first batch of processing requests in queue arrival order.

The agent 510 that may be configured to store one or more allocation-type requests as cluster-level requests. The agent 510 that may be configured to read a processing request from a storage and slice the processing request responsive to reading the processing request from the storage.

The resource manager 102 includes a network interface 506 configured to establish a communication session with a computing device for sending and receiving data over the communication network 120 to the computing device. Accordingly, the network interface 506 includes a cellular transceiver (supporting cellular standards), a local wireless network transceiver (supporting 802.11X, ZigBee, Bluetooth, Wi-Fi, or the like), a wired network interface, a combination thereof (e.g., both a cellular transceiver and a Bluetooth transceiver), and/or the like. In some embodiments, the resource manager 102 includes a plurality of network interfaces 506 of different types, allowing for connections to a variety of networks, such as local area networks (public or private) or wide area networks including the Internet, via different sub-networks.

The resource manager 102 includes an input/output device 505 configured to receive user input from and provide information to a user. In this regard, the input/output device 505 is structured to exchange data, communications, instructions, etc. with an input/output component of the resource manager 102. Accordingly, input/output device 505 may be any electronic device that conveys data to a user by generating sensory information (e.g., a visualization on a display, one or more sounds, tactile feedback, etc.) and/or converts received sensory information from a user into electronic signals (e.g., a keyboard, a mouse, a pointing device, a touch screen display, a microphone, etc.). The one or more user interfaces may be internal to the housing of resource manager 102, such as a built-in display, touch screen, microphone, etc., or external to the housing of resource manager 102, such as a monitor connected to resource manager 102, a speaker connected to resource manager 102, etc., according to various embodiments. In some embodiments, the resource manager 102 includes communication circuitry for facilitating the exchange of data, values, messages, and the like between the input/output device 505 and the components of the resource manager 102. In some embodiments, the input/output device 505 includes machine-readable media for facilitating the exchange of information between the input/output device 505 and the components of the resource manager 102. In still another embodiment, the input/output device 505 includes any combination of hardware components (e.g., a touchscreen), communication circuitry, and machine-readable media.

The resource manager 102 includes a device identification component 507 (shown in FIG. 5 as device ID component 507) configured to generate and/or manage a device identifier associated with the resource manager 102. The device identifier may include any type and form of identification used to distinguish the resource manager 102 from other computing devices. In some embodiments, to preserve privacy, the device identifier may be cryptographically generated, encrypted, or otherwise obfuscated by any device and/or component of resource manager 102. In some embodiments, the resource manager 102 may include the device identifier in any communication (e.g., task assignment, etc.) that the resource manager 102 sends to a computing device.

The resource manager 102 includes a bus (not shown), such as an address/data bus or other communication mechanism for communicating information, which interconnects the devices and/or components of resource manager 102, such as processing device 502, network interface 506, input/output device 505, and device ID component 507.

In some embodiments, some or all of the devices and/or components of resource manager 102 may be implemented with the processing device 502. For example, the resource manager 102 may be implemented as a software application stored within the memory 504 and executed by the processing device 502. Accordingly, such embodiment can be implemented with minimal or no additional hardware costs. In some embodiments, any of these above-recited devices and/or components rely on dedicated hardware specifically configured for performing operations of the devices and/or components.

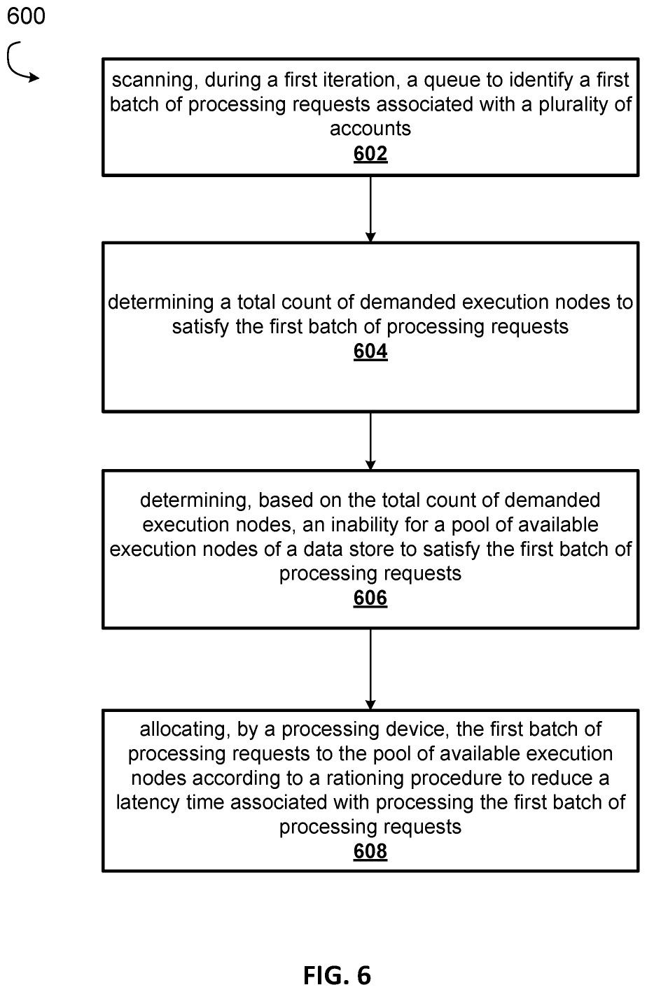

FIG. 6 is a flow diagram depicting a method of execution node provisioning of a data store with fairness during oversubscription, according to some embodiments. Method 600 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, one or more blocks of the method 500 may be performed by one or more resource managers, such as resource manager 102 in FIG. 3. In some embodiments, one or more blocks of the method 600 may be performed by one or more execution platforms, such as execution platform 312 in FIG. 3.

With reference to FIG. 6, method 600 illustrates example functions used by various embodiments. Although specific function blocks (“blocks”) are disclosed in method 600, such blocks are examples. That is, embodiments are well suited to performing various other blocks or variations of the blocks recited in method 600. It is appreciated that the blocks in method 600 may be performed in an order different than presented, and that not all of the blocks in method 600 may be performed.

As shown in FIG. 6, the method 600 includes the block 602 of scanning, during a first iteration, a queue to identify a first batch of processing requests associated with a plurality of accounts. The method 600 includes the block 604 of determining a total count of demanded execution nodes to satisfy the first batch of processing requests. The method 600 includes the block 606 of determining, based on the total count of demanded execution nodes, an inability for a pool of available execution nodes of a data store to satisfy the first batch of processing requests. The method 600 includes the block 608 of allocating, by a processing device, the first batch of processing requests to the pool of available execution nodes according to a rationing procedure to reduce a latency time associated with processing the first batch of processing requests.

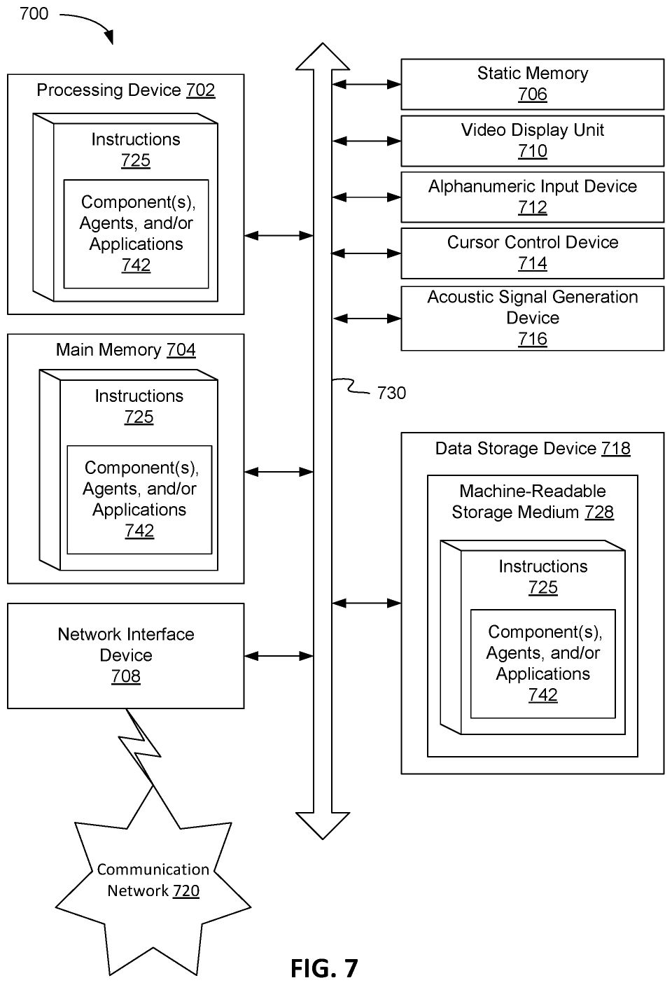

FIG. 7 is a block diagram of an example computing device 700 that may perform one or more of the operations described herein, in accordance with some embodiments. Computing device 700 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 700 may include a processing device (e.g., a general-purpose processor, a PLD, etc.) 702, a main memory 704 (e.g., synchronous dynamic random-access memory (DRAM), read-only memory (ROM)), a static memory 706 (e.g., flash memory and a data storage device 718), which may communicate with each other via a bus 730.

Processing device 702 may be provided by one or more general-purpose processing devices such as a microprocessor, central processing unit, or the like. In an illustrative example, processing device 702 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 702 may also include one or more special-purpose processing devices such as an application specific integrated circuit (ASIC), a field programmable gate array (FPGA), a digital signal processor (DSP), network processor, or the like. The processing device 702 may be configured to execute the operations described herein, in accordance with one or more aspects of the present disclosure, for performing the operations and steps discussed herein.

Computing device 700 may further include a network interface device 708 which may communicate with a communication network 720. The computing device 700 also may include a video display unit 710 (e.g., a liquid crystal display (LCD) or a cathode ray tube (CRT)), an alphanumeric input device 712 (e.g., a keyboard), a cursor control device 714 (e.g., a mouse) and an acoustic signal generation device 716 (e.g., a speaker). In one embodiment, video display unit 710, alphanumeric input device 712, and cursor control device 714 may be combined into a single component or device (e.g., an LCD touch screen).

Data storage device 718 may include a computer-readable storage medium 728 on which may be stored one or more sets of instructions 725 that may include instructions for one or more components/agents/applications 742 (e.g., EFPM agent 510 in FIG. 5, etc.) for carrying out the operations described herein, in accordance with one or more aspects of the present disclosure. Instructions 725 may also reside, completely or at least partially, within main memory 704 and/or within processing device 702 during execution thereof by computing device 700, main memory 704 and processing device 702 also constituting computer-readable media. The instructions 725 may further be transmitted or received over a communication network 720 via network interface device 708.

While computer-readable storage medium 728 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

### EXAMPLES

The following examples pertain to further embodiments:

Example 1 is a method. The method includes scanning, during a first iteration, a queue to identify a first batch of processing requests associated with a plurality of accounts; determining a total count of demanded execution nodes to satisfy the first batch of processing requests; determining, based on the total count of demanded execution nodes, an inability for a pool of available execution nodes of a data store to satisfy the first batch of processing requests; and allocating, by a processing device, the first batch of processing requests to the pool of available execution nodes according to a rationing procedure to reduce a latency time associated with processing the first batch of processing requests.

Example 2 is a method as in Example 2, further including determining a total count of available execution nodes in the pool of available execution nodes; and determining that the total count of available execution nodes in the pool of available execution nodes is less than the total count of demanded execution nodes.

Example 3 is a method as in any of Examples 1-2, further including generating a considered demand vector based on a first count of demanded execution nodes to process a first processing request associated with a first account of the plurality of accounts and a second count of demanded execution nodes to process a second processing request associated with a second account of the plurality of accounts.

Example 4 is a method as in any of Examples 1-3, further including generating a total demand vector based on the total count of demanded execution nodes associated with the plurality of accounts.

Example 5 is a method as in any of Examples 1-4, further including calculating a total execution node considered for the second account based on the considered demand vector and the total demand vector; calculating a total considered for the second account based on the considered demand vector; determining that the total considered for the second account exceeds a predetermined threshold value; preventing an allocation of an execution node for processing the second processing request responsive to determining that the total considered for the second account exceeds the predetermined threshold value; and scanning, during a second iteration after preventing the allocation of the execution node for the processing the second processing request, the queue to identify a different batch of processing requests associated with the plurality of accounts.

Example 6 is a method as in any of Examples 1-5, further including maintaining, over a plurality of scanning iterations, a history of at least one of a considered demand vector or a total demand vector based on a sliding window or an exponential decay procedure.

Example 7 is a method as in any of Examples 1-6, further including generating, based on a size of the data store, a first considered demand vector and first total demand vector; and generating, based on the plurality of accounts, a second considered demand vector and a second total demand vector.

Example 8 is a method as in any of Examples 1-7, further including scanning, during a second iteration, the queue to identify a second batch of processing requests associated with the plurality of accounts; and processing the first batch of processing requests and the second batch of processing requests in parallel.

Example 9 is a method as in any of Examples 1-8, further including at least one of processing a release-type request before an allocate type request; processing a first request having a smallest data store size before a second request having a largest data store size; or processing the first batch of processing requests in queue arrival order.

Example 10 is a method as in any of Examples 1-9, further including at least one of storing one or more allocation-type requests as cluster-level requests; or reading a processing request from a storage; and slicing the processing request responsive to reading the processing request from the storage.

Example 11 is a system. The system includes a memory; and a processing device, operatively coupled to the memory, to scan, during a first iteration, a queue to identify a first batch of processing requests associated with a plurality of accounts; determine a total count of demanded execution nodes to satisfy the first batch of processing requests; determine, based on the total count of demanded execution nodes, an inability for a pool of available execution nodes of a data store to satisfy the first batch of processing requests; and allocate the first batch of processing requests to the pool of available execution nodes according to a rationing procedure to reduce a latency time associated with processing the first batch of processing requests.

Example 12 is a system as in Example 11, wherein the processing device is further to determine, based on the total count of demanded execution nodes, the inability for the pool of available execution nodes of the data store to satisfy the first batch of processing requests, the processing device is further to determine a total count of available execution nodes in the pool of available execution nodes; and determine that the total count of available execution nodes in the pool of available execution nodes is less than the total count of demanded execution nodes.

Example 13 is a system as in any of Examples 11-12, wherein the processing device is further to allocate the first batch of processing requests to the pool of available execution nodes according to the rationing procedure, the processing device is further to generate a considered demand vector based on a first count of demanded execution nodes to process a first processing request associated with a first account of the plurality of accounts and a second count of demanded execution nodes to process a second processing request associated with a second account of the plurality of accounts.

Example 14 is a system as in any of Examples 11-13, wherein a total count of execution nodes that is indicated by the considered demand vector is less than the total count of demanded execution nodes, and wherein the processing device is further to generate a total demand vector based on the total count of demanded execution nodes associated with the plurality of accounts.

Example 15 is a system as in any of Examples 11-14, wherein the processing device is further to calculate a total execution node considered for the second account based on the considered demand vector and the total demand vector; calculate a total considered for the second account based on the considered demand vector; determine that the total considered for the second account exceeds a predetermined threshold value; prevent an allocation of an execution node for processing the second processing request responsive to determining that the total considered for the second account exceeds the predetermined threshold value; and scan, during a second iteration after preventing the allocation of the execution node for the processing the second processing request, the queue to identify a different batch of processing requests associated with the plurality of accounts.

Example 16 is a system as in any of Examples 11-15, wherein to allocate the first batch of processing requests to the pool of available execution nodes according to the rationing procedure to reduce the latency time associated with processing the first batch of processing requests, the processing device is further to maintain, over a plurality of scanning iterations, a history of at least one of a considered demand vector or a total demand vector based on a sliding window or an exponential decay procedure.

Example 17 is a system as in any of Examples 11-16, wherein to generate, based on a size of the data store, a first considered demand vector and first total demand vector; and generate, based on the plurality of accounts, a second considered demand vector and a second total demand vector.

Example 18 is a system as in any of Examples 11-17, wherein to scan, during a second iteration, the queue to identify a second batch of processing requests associated with the plurality of accounts; and process the first batch of processing requests and the second batch of processing requests in parallel.

Example 19 is a system as in any of Examples 11-18, wherein the processing device is further to at least one of process a release-type request before an allocate type request; process a first request having a smallest data store size before a second request having a largest data store size; or process the first batch of processing requests in queue arrival order.

Example 20 is a system as in any of Examples 11-19, wherein the processing device is further to at least one of store one or more allocation-type requests as cluster-level requests; or read a processing request from a storage; and slice the processing request responsive to reading the processing request from the storage.

Example 21 is a non-transitory computer-readable medium storing instructions that, when execute by a processing device of a system, cause the processing device to scan, during a first iteration, a queue to identify a first batch of processing requests associated with a plurality of accounts; determine a total count of demanded execution nodes to satisfy the first batch of processing requests; determine, based on the total count of demanded execution nodes, an inability for a pool of available execution nodes of a data store to satisfy the first batch of processing requests; and allocate, by the processing device, the first batch of processing requests to the pool of available execution nodes according to a rationing procedure to reduce a latency time associated with processing the first batch of processing requests.

Example 22 is a non-transitory computer-readable medium as in Example 21, wherein the instructions, when executed by a processing device, further cause the processing device to determine a total count of available execution nodes in the pool of available execution nodes; and determine that the total count of available execution nodes in the pool of available execution nodes is less than the total count of demanded execution nodes.

Example 23 is a non-transitory computer-readable medium as in any of Example 21-22, wherein the instructions, when executed by the processing device, further cause the processing device to generate a considered demand vector based on a first count of demanded execution nodes to process a first processing request associated with a first account of the plurality of accounts and a second count of demanded execution nodes to process a second processing request associated with a second account of the plurality of accounts.

Example 24 is a non-transitory computer-readable medium as in any of Example 21-23, wherein the instructions, when executed by the processing device, further cause the processing device to generate a total demand vector based on the total count of demanded execution nodes associated with the plurality of accounts, and wherein a total count of execution nodes that is indicated by the considered demand vector is less than the total count of demanded execution nodes.

Example 25 is a non-transitory computer-readable medium as in any of Example 21-24, wherein the instructions, when executed by the processing device, further cause the processing device to calculate a total execution node considered for the second account based on the considered demand vector and the total demand vector; calculate a total considered for the second account based on the considered demand vector; determine that the total considered for the second account exceeds a predetermined threshold value; prevent an allocation of an execution node for processing the second processing request responsive to determining that the total considered for the second account exceeds the predetermined threshold value; and scan, during a second iteration after preventing the allocation of the execution node for the processing the second processing request, the queue to identify a different batch of processing requests associated with the plurality of accounts.

Example 26 is a non-transitory computer-readable medium as in any of Example 21-25, wherein the instructions, when executed by the processing device, further cause the processing device to maintain, over a plurality of scanning iterations, a history of at least one of a considered demand vector or a total demand vector based on a sliding window or an exponential decay procedure.

Example 27 is a non-transitory computer-readable medium as in any of Example 21-26, wherein the instructions, when executed by the processing device, further cause the processing device to generate, based on a size of the data store, a first considered demand vector and first total demand vector; and generate, based on the plurality of accounts, a second considered demand vector and a second total demand vector.

Example 28 is a non-transitory computer-readable medium as in any of Example 21-27, wherein the instructions, when executed by the processing device, further cause the processing device to scan, during a second iteration, the queue to identify a second batch of processing requests associated with the plurality of accounts; and process the first batch of processing requests and the second batch of processing requests in parallel.

Example 29 is a non-transitory computer-readable medium as in any of Example 21-28, wherein the instructions, when executed by the processing device, further cause the processing device to at least one of process a release-type request before an allocate type request; process a first request having a smallest data store size before a second request having a largest data store size; or process the first batch of processing requests in queue arrival order.

Example 30 is a non-transitory computer-readable medium as in any of Example 21-29, wherein the instructions, when executed by the processing device, further cause the processing device to at least one of store one or more allocation-type requests as cluster-level requests; or read a processing request from a storage; and slice the processing request responsive to reading the processing request from the storage.

Unless specifically stated otherwise, terms such as “scanning,” “determining,” “allocating,” “receiving,” “monitoring,” “identifying,” “generating,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware--for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present embodiments to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present embodiments are not to be limited to the details given herein, but may be modified within the scope and equivalents of the appended claims.

What is claimed is:

1. A method comprising:
scanning, during a first iteration, a queue to identify a first batch of processing requests associated with a plurality of accounts;
determining a total count of demanded execution nodes to satisfy the first batch of processing requests;
determining, based on the total count of demanded execution nodes, an inability for a pool of available execution nodes of a data store to satisfy the first batch of processing requests; and
allocating, by a processing device, the first batch of processing requests to the pool of available execution nodes according to a rationing procedure to reduce a latency time associated with processing the first batch of processing requests.

2. The method of claim 1, wherein determining, based on the total count of demanded execution nodes, the inability for the pool of available execution nodes of the data store to satisfy the first batch of processing requests comprises:
determining a total count of available execution nodes in the pool of available execution nodes; and
determining that the total count of available execution nodes in the pool of available execution nodes is less than the total count of demanded execution nodes.

3. The method of claim 1, wherein allocating the first batch of processing requests to the pool of available execution nodes according to the rationing procedure further comprises:
generating a considered demand vector based on a first count of demanded execution nodes to process a first processing request associated with a first account of the plurality of accounts and a second count of demanded execution nodes to process a second processing request associated with a second account of the plurality of accounts.

4. The method of claim 3, wherein a total count of execution nodes that is indicated by the considered demand vector is less than the total count of demanded execution nodes, and further comprising:
generating a total demand vector based on the total count of demanded execution nodes associated with the plurality of accounts.

5. The method of claim 4, further comprising:
calculating a total execution node considered for the second account based on the considered demand vector and the total demand vector;
calculating a total considered for the second account based on the considered demand vector;
determining that the total considered for the second account exceeds a predetermined threshold value;
preventing an allocation of an execution node for processing the second processing request responsive to determining that the total considered for the second account exceeds the predetermined threshold value; and
scanning, during a second iteration after preventing the allocation of the execution node for the processing the second processing request, the queue to identify a different batch of processing requests associated with the plurality of accounts.

6. The method of claim 1, wherein allocating the first batch of processing requests to the pool of available execution nodes according to the rationing procedure to reduce the latency time associated with processing the first batch of processing requests further comprises:
maintaining, over a plurality of scanning iterations, a history of at least one of a considered demand vector or a total demand vector based on a sliding window or an exponential decay procedure.

7. The method of claim 1, further comprising:
generating, based on a size of the data store, a first considered demand vector and first total demand vector; and
generating, based on the plurality of accounts, a second considered demand vector and a second total demand vector.

8. The method of claim 7, further comprising:
scanning, during a second iteration, the queue to identify a second batch of processing requests associated with the plurality of accounts; and
processing the first batch of processing requests and the second batch of processing requests in parallel.

9. The method of claim 1, wherein at least one of:
processing a release-type request before an allocate type request;
processing a first request having a smallest data store size before a second request having a largest data store size; or
processing the first batch of processing requests in queue arrival order.

10. The method of claim 1, further comprising at least one of:
storing one or more allocation-type requests as cluster-level requests; or
reading a processing request from a storage; and
slicing the processing request responsive to reading the processing request from the storage.

11. A system comprising:
a memory; and
a processing device, operatively coupled to the memory, to:
scan, during a first iteration, a queue to identify a first batch of processing requests associated with a plurality of accounts;
determine a total count of demanded execution nodes to satisfy the first batch of processing requests;
determine, based on the total count of demanded execution nodes, an inability for a pool of available execution nodes of a data store to satisfy the first batch of processing requests; and
allocate the first batch of processing requests to the pool of available execution nodes according to a rationing procedure to reduce a latency time associated with processing the first batch of processing requests.

12. The system of claim 11, wherein to determine, based on the total count of demanded execution nodes, the inability for the pool of available execution nodes of the data store to satisfy the first batch of processing requests, the processing device is further to:
determine a total count of available execution nodes in the pool of available execution nodes; and
determine that the total count of available execution nodes in the pool of available execution nodes is less than the total count of demanded execution nodes.

13. The system of claim 11, wherein to allocate the first batch of processing requests to the pool of available execution nodes according to the rationing procedure, the processing device is further to:
generate a considered demand vector based on a first count of demanded execution nodes to process a first processing request associated with a first account of the plurality of accounts and a second count of demanded execution nodes to process a second processing request associated with a second account of the plurality of accounts.

14. The system of claim 13, wherein a total count of execution nodes that is indicated by the considered demand vector is less than the total count of demanded execution nodes, and wherein the processing device is further to:
generate a total demand vector based on the total count of demanded execution nodes associated with the plurality of accounts.

15. The system of claim 14, wherein the processing device is further to:
calculate a total execution node considered for the second account based on the considered demand vector and the total demand vector;
calculate a total considered for the second account based on the considered demand vector;
determine that the total considered for the second account exceeds a predetermined threshold value;
prevent an allocation of an execution node for processing the second processing request responsive to determining that the total considered for the second account exceeds the predetermined threshold value; and
scan, during a second iteration after preventing the allocation of the execution node for the processing the second processing request, the queue to identify a different batch of processing requests associated with the plurality of accounts.

16. The system of claim 11, wherein to allocate the first batch of processing requests to the pool of available execution nodes according to the rationing procedure to reduce the latency time associated with processing the first batch of processing requests, the processing device is further to:
maintain, over a plurality of scanning iterations, a history of at least one of a considered demand vector or a total demand vector based on a sliding window or an exponential decay procedure.

17. The system of claim 11, wherein the processing device is further to:
generate, based on a size of the data store, a first considered demand vector and first total demand vector; and
generate, based on the plurality of accounts, a second considered demand vector and a second total demand vector.

18. The system of claim 17, wherein the processing device is further to:
scan, during a second iteration, the queue to identify a second batch of processing requests associated with the plurality of accounts; and
process the first batch of processing requests and the second batch of processing requests in parallel.

19. The system of claim 11, wherein the processing device is further to at least one of:
process a release-type request before an allocate type request;
process a first request having a smallest data store size before a second request having a largest data store size; or
process the first batch of processing requests in queue arrival order.

20. The system of claim 11, wherein the processing device is further to at least one of:
store one or more allocation-type requests as cluster-level requests; or
read a processing request from a storage; and
slice the processing request responsive to reading the processing request from the storage.

21. A non-transitory computer-readable medium storing instructions that, when execute by a processing device, cause the processing device to:
scan, during a first iteration, a queue to identify a first batch of processing requests associated with a plurality of accounts;
determine a total count of demanded execution nodes to satisfy the first batch of processing requests;
determine, based on the total count of demanded execution nodes, an inability for a pool of available execution nodes of a data store to satisfy the first batch of processing requests; and
allocate, by the processing device, the first batch of processing requests to the pool of available execution nodes according to a rationing procedure to reduce a latency time associated with processing the first batch of processing requests.

22. The non-transitory computer-readable medium of claim 21, wherein the instructions, when executed by the processing device, further cause the processing device to:
determine a total count of available execution nodes in the pool of available execution nodes; and
determine that the total count of available execution nodes in the pool of available execution nodes is less than the total count of demanded execution nodes.

23. The non-transitory computer-readable medium of claim 21, wherein the instructions, when executed by the processing device, further cause the processing device to:
generate a considered demand vector based on a first count of demanded execution nodes to process a first processing request associated with a first account of the plurality of accounts and a second count of demanded execution nodes to process a second processing request associated with a second account of the plurality of accounts.

24. The non-transitory computer-readable medium of claim 23, wherein the instructions, when executed by the processing device, further cause the processing device to:
generate a total demand vector based on the total count of demanded execution nodes associated with the plurality of accounts, and
wherein a total count of execution nodes that is indicated by the considered demand vector is less than the total count of demanded execution nodes.

25. The non-transitory computer-readable medium of claim 24, wherein the instructions, when executed by the processing device, further cause the processing device to:
calculate a total execution node considered for the second account based on the considered demand vector and the total demand vector;
calculate a total considered for the second account based on the considered demand vector;
determine that the total considered for the second account exceeds a predetermined threshold value;
prevent an allocation of an execution node for processing the second processing request responsive to determining that the total considered for the second account exceeds the predetermined threshold value; and
scan, during a second iteration after preventing the allocation of the execution node for the processing the second processing request, the queue to identify a different batch of processing requests associated with the plurality of accounts.

26. The non-transitory computer-readable medium of claim 21, wherein the instructions, when executed by the processing device, further cause the processing device to:
maintain, over a plurality of scanning iterations, a history of at least one of a considered demand vector or a total demand vector based on a sliding window or an exponential decay procedure.

27. The non-transitory computer-readable medium of claim 21, wherein the instructions, when executed by the processing device, further cause the processing device to:
generate, based on a size of the data store, a first considered demand vector and first total demand vector; and
generate, based on the plurality of accounts, a second considered demand vector and a second total demand vector.

28. The non-transitory computer-readable medium of claim 27, wherein the instructions, when executed by the processing device, further cause the processing device to:
scan, during a second iteration, the queue to identify a second batch of processing requests associated with the plurality of accounts; and
process the first batch of processing requests and the second batch of processing requests in parallel.

29. The non-transitory computer-readable medium of claim 21, wherein the instructions, when executed by the processing device, further cause the processing device to at least one of:
process a release-type request before an allocate type request;
process a first request having a smallest data store size before a second request having a largest data store size; or
process the first batch of processing requests in queue arrival order.

30. The non-transitory computer-readable medium of claim 21, wherein the instructions, when executed by the processing device, further cause the processing device to at least one of:
store one or more allocation-type requests as cluster-level requests; or
read a processing request from a storage; and
slice the processing request responsive to reading the processing request from the storage.
